(19) United States
(12) Patent Application Publication
(10) Pub. No.: US 2007/0059979 A1
(43) Pub. Date: Mar. 15, 2007

(54) Waterproof housing

(75) Inventor: Sheng-Hsiung Yang, Hsinchu County (TW)

Correspondence Address: BIRCH STEWART KOLASCH & BIRCH, PO BOX 747, FALLS CHURCH, VA, 22040-0747, US

(73) Assignee: SmartAnt Telecom Co., Ltd.

(21) Appl. No.: 11/513,141

(22) Filed: Aug. 31, 2006

(30) Foreign Application Priority Data
Sep. 9, 2005 (TW) 094215620

(51) Int. Cl. H01R 13/60

(52) U.S. Cl. 439/540.1

(57) ABSTRACT

A waterproof housing is provided, which includes a first housing cover and a second housing cover that are snapped with each other to form an inner chamber, wherein the first housing cover has a closed annular-shaped outer retaining wall on one side and an inner retaining wall; a channel is naturally formed there-between; and the second housing cover has a closed annular-shaped embedding wall on one side that is correspondingly embedded into the channel. The housing formed by combining the outer retaining wall with the inner retaining wall takes the two retaining walls as two defenses to prevent the rain or foreign matters from entering into the chamber. Even if the rain penetrates into the channel via a gap by accident, the rain flows to the bottom part along the channel and is discharged from the drain holes disposed at the bottom, without being retained in the housing.

### CROSS-REFERENCE TO RELATED APPLICATIONS

This non-provisional application claims priority under 35 U.S.C. §119(a) on Patent Application No(s). 094215620 filed in Taiwan, R.O.C. on Sep. 9, 2006, the entire contents of which are hereby incorporated by reference.

### BACKGROUND OF THE UTILITY MODEL

1. Field of the Utility Model

The present utility model relates to a waterproof housing, and more particularly, to a housing used for an outdoor antenna or various outdoor equipments, and especially to the housing having a structure for preventing water from penetrating into the housing.

2. Related Art

Taking an outdoor antenna as an example, a waterproof housing for integrating all the parts therein is required, in order to integrate all the parts and ensure that the rain or foreign matters are prevented from directly falling on the parts and damaging them when the parts are used outdoors after being mounted.

Most of the housings employed in various common outdoor antennas are multi-part composite constructions formed by plastic, wherein after inner parts have been mounted, the housings are locked by screws or adhered by glue, so as to protect the inner components. Moreover, in order to prevent the rain or foreign matters from entering into the housing and causing damages to the inner components, the operators usually take the waterproof problem into consideration and take it as one of the factors for designing the housing structure, for example, adding a waterproof bar into the combination gap or adding a flashing board above the housing are both common solutions.

However, since a long time ago, no matter the housing of the outdoor antenna adopts the design of locking by screws or adhering by glue, when the housing is exposed in the outdoor environment for a long time, a loosening phenomenon occurs due to the corrosion of the screws or the cracking of the adhesives.

Moreover, the ever adopted solutions of the waterproof problem of the housing not only have a limited effect, but also the housing structure is more complicated and consumes more labor-hours when being mounted.

### SUMMARY OF THE UTILITY MODEL

In view of the disadvantages of the outdoor housing in terms of the structure and the waterproof function, a main objective of the present utility model is to provide a housing with a simple structure, a high combination intensity, and a waterproof function.

In order to achieve the above objective, the present utility model provides a waterproof housing structure, which comprises a first housing cover and a second housing cover that are snapped with each other to form an inner chamber, wherein the first housing cover has a closed annular-shaped outer retaining wall on one side and an inner retaining wall; a channel is naturally formed there-between; and the second housing cover has a closed annular-shaped embedding wall on one side, which is correspondingly embedded into the channel.

Therefore, the housing utilizes the outer retaining wall and the inner retaining wall as two defenses to prevent the rain or foreign matters from entering into the chamber, and even if the rain penetrates into the channel via a combination gap by accident, the rain flows to the bottom part along the channel and is discharged from drain holes disposed at the bottom.

Further scope of applicability of the present utility model will become apparent from the detailed description given hereinafter. However, it should be understood that the detailed description and specific examples, while indicating preferred embodiments of the utility model, are given by way of illustration only, since various changes and modifications within the spirit and scope of the utility model will become apparent to those skilled in the art from this detailed description.

### BRIEF DESCRIPTION OF THE DRAWINGS

The present utility model will become more fully understood from the detailed description given herein below for illustration only, which thus is not limitative of the present utility model, and wherein:

FIG. 1 is an exploded stereogram of a waterproof housing of the present utility model, wherein two housing covers are combined correspondingly to form a housing;

FIG. 2A-2B is a stereogram of the waterproof housing of the present utility model after the two housing covers have been combined;

FIG. 3 is a front view seen from the inner side of a housing cover of the waterproof housing of the present utility model;

FIG. 4 is a cutaway view obtained at the position of A-A in FIG. 3;

FIG. 5 is a front view seen from the inner side of the other housing cover of the waterproof housing of the present utility model;

FIG. 6 is a cutaway view obtained at the position of B-B in FIG. 5; and

FIG. 7A-7B is a cutaway view of the two combined housing covers of the waterproof housing of the present utility model.

### DETAILED DESCRIPTION OF THE UTILITY MODEL

In order to further understand the technical content and elements of the construction disclosed in the present utility model, the present utility model is described below with reference to accompanying drawings given herein. However, the accompanied drawings are only used for reference and illustration, but not limiting the present utility model.

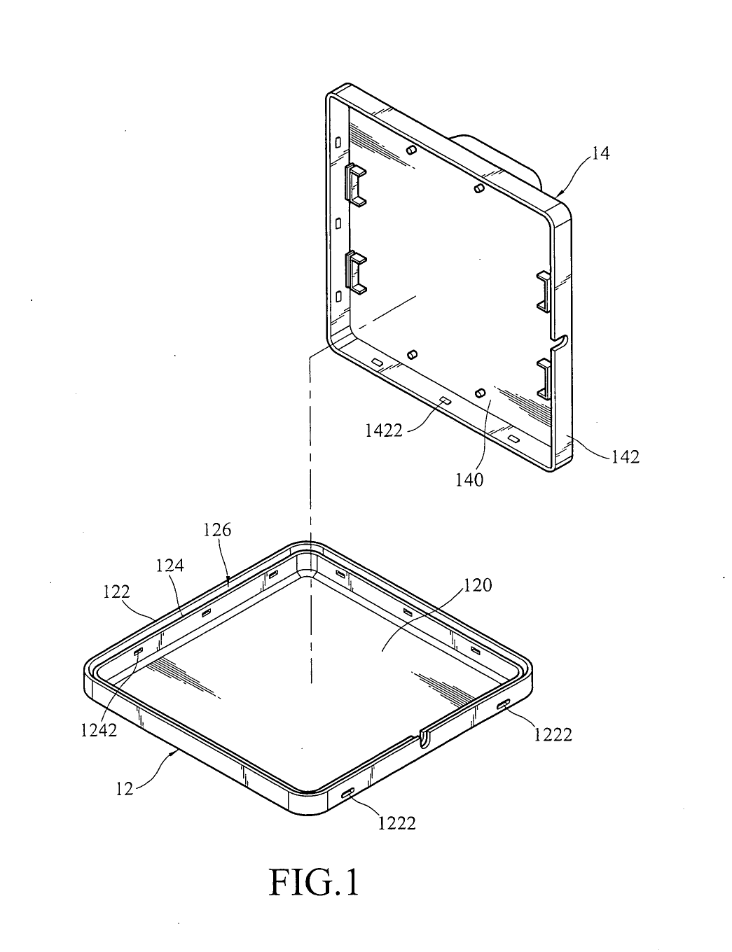

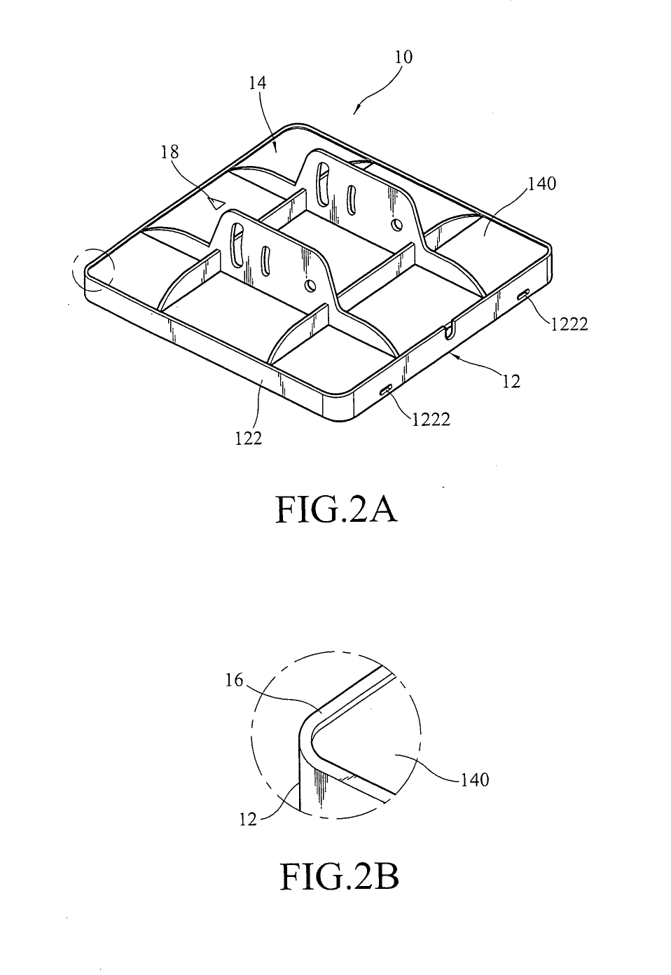

FIG. 1 is an exploded view of a waterproof housing structure, wherein two housing covers are combined correspondingly to form a housing, and FIG. 2 shows the state after the two housing covers have been combined. As shown in figures, the waterproof housing 10 includes a first housing cover 12 and a second housing cover 14, which are combined with each other to form an inner chamber. The first housing cover 12 has a closed annular-shape outer retaining wall 122 on one side and an inner retaining wall 124, and an annular channel 126 is naturally formed between the outer retaining wall 122 and the inner retaining wall 124. Corresponding to the structure of the first housing cover, the above second housing cover 14 has a closed annular-shape embedding wall 142 on one side that is correspondingly embedded into the channel 126 and snapped with the inner retaining wall 124.

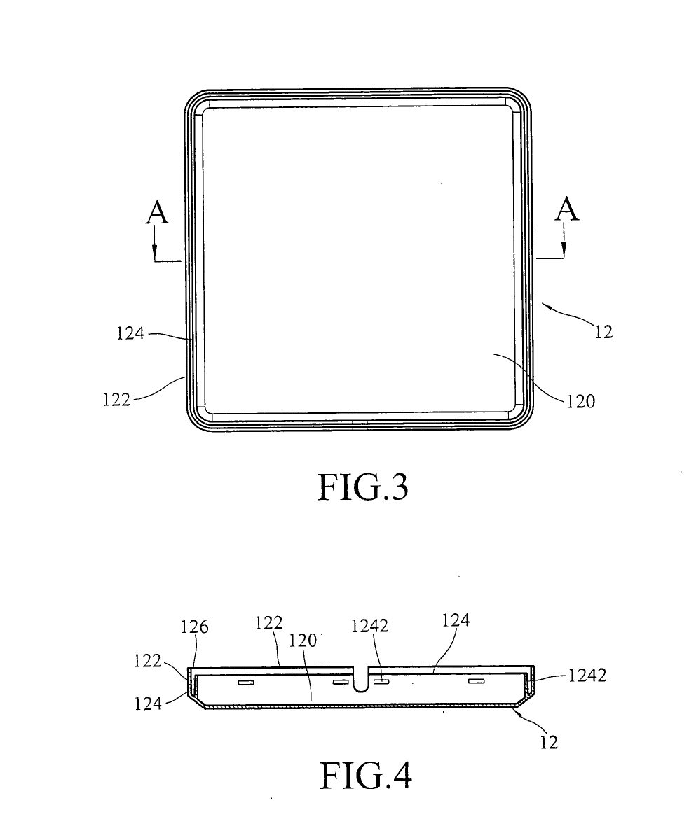

FIG. 3 is a front view seen from the inner side of a first housing cover, and FIG. 4 is a cutaway view obtained at the position of A-A in FIG. 3. As shown in figures, the first housing cover 12 includes a base plate 120 and a closed outer retaining wall 122 vertically extending from an edge to one side of the base plate 120, wherein the outer retaining wall 122 has an open through-hole on one side and has a closed inner retaining wall 124 on an inner edge that is also vertically extended from the base plate 120. The inner retaining wall 124 has a plurality of slots 1242, the vertical height of the inner retaining wall 124 is slightly lower than that of the outer retaining wall 122, and an appropriate parallel distance is existed between the inner and outer retaining walls 124, 122.

With the above configuration, the first housing cover 12 has two vertically extending retaining walls with a channel 126 naturally formed there-between, wherein the channel 126 is not only used for combining with the second housing cover 14, but also used as a drain channel. Furthermore, more than one through-hole is disposed on the outer retaining wall 122 and communicated with the channel 126, which are defined as drain holes 1222 for draining waters.

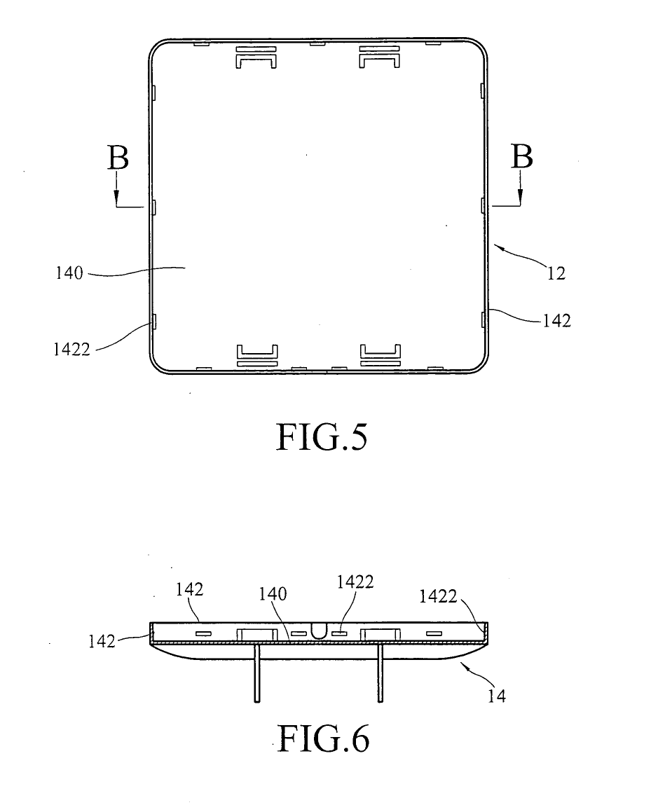

FIG. 5 is a front view seen from the inner side of a second housing cover, and FIG. 6 is a cutaway view obtained at the position of B-B in FIG. 5. As shown in figures, the second housing cover 14 includes a base plate 140 and a closed embedding wall 142 vertically extending from an edge to one side of the base plate 140, wherein the embedding wall 142 is correspondingly embedded into the channel 126 of the first housing cover 12 and it has slots 1242 for being snapped with the inner retaining wall 124.

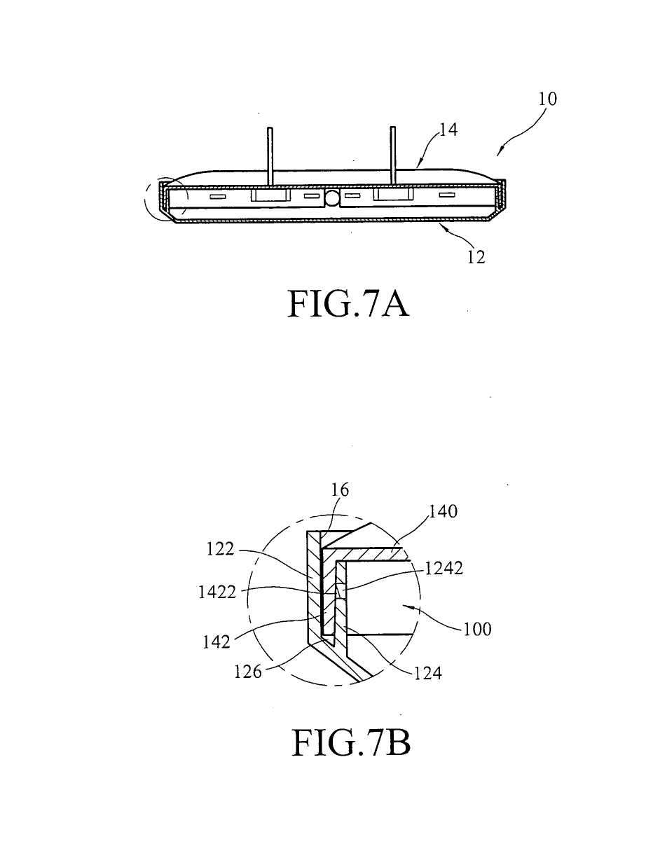

FIG. 7A-7B is a cutaway view obtained when the two housing covers are combined. When the second housing cover 14 is embedded into the channel 126 on the first housing cover 12 via the embedding wall 142 and snapped therein, a closed inner chamber 100 is formed between the first housing cover 12 and the second housing cover 14, which is used for antenna parts to be mounted and fixed therein.

When the first housing cover 12 and the second housing cover 14 bear against and combine with each other, the hooks 1422 on the embedding wall 142 are snapped with the slots 1242 correspondingly disposed on the inner retaining wall 124, so as to connect the two housing covers. The adjacent surfaces of the inner retaining wall 124 and the embedding wall 142 are matching chamfers with the design of draft matching chamfer, so that the combination intensity of the two housing covers is gained from both the draft bevel and the matching between the hook 1422 and the slot 1242, thus, the preferred combination intensity can be achieved simply by way of snapping.

After the first housing cover 12 and the second housing cover 14 have been combined, as shown in the partial enlarged view, the length of the outer retaining wall 122 of the first housing cover 12 exceeds that of the outer edge of the second housing cover 14 for a certain distance, so as to form a siding 16 on the housing 10. With the shielding effect provided by the siding 16, it is more difficult for the rain or foreign matters to directly penetrate into the housing 10 via the combination gap.

If the rain or the accompanied foreign matters penetrates into the housing 10 via the gap by accident, the rain does not directly flow into the chamber 100, but falls to the channel 126 formed between the two retaining walls, and finally, the rain is discharged from the drain holes 1222 disposed on the bottom end of the first housing cover 12, without being retaining or accumulated within the housing 10.

Since the drain holes 1222 on the first housing cover 12 are disposed on the bottom end, when the housing 10 is hanged outdoors in the state of bottom-down, the rain penetrated into the channel 126 by accident flows along the channel 126 towards the drain holes 1222 on the bottom end. In order to mark the correct hanging direction of the housing 10, a direction indicator 18 is disposed on the first housing cover 12 or the second housing cover 14 for identification during the implementation.

To sum up, a housing structure with superior waterproof function is disclosed above, which has a simple structure and preferred combination intensity.

The utility model being thus described, it will be obvious that the same may be varied in many ways. Such variations are not to be regarded as a departure from the spirit and scope of the utility model, and all such modifications as would be obvious to one skilled in the art are intended to be included within the scope of the following claims.

What is claimed is:

1. A waterproof housing, comprising a first housing cover and a second housing cover that are snapped with each other to form an inner chamber, wherein the first housing cover has a closed annular-shaped outer retaining wall on one side and an inner retaining wall; a channel is formed there-between; and the second housing cover has a closed annular-shaped embedding wall on one side that is correspondingly embedded into the channel and snapped with the inner retaining wall.

2. The waterproof housing as claimed in claim 1, wherein the inner retaining wall and the embedding wall are correspondingly provided with slots and hooks that are snapped with each other.

3. The waterproof housing as claimed in claim 1, wherein the first housing cover has more than one drain holes on an outer edge, which are communicated with the channel.

4. The waterproof housing as claimed in claim 3, wherein the first housing cover defines a bottom end, and the drain holes are disposed at the bottom end of the first housing cover.

5. The waterproof housing as claimed in claim 4, wherein a direction indicator is disposed on the first housing cover.

6. The waterproof housing as claimed in claim 4, wherein a direction indicator is disposed on the second housing cover.

7. The waterproof housing as claimed in claim 1, wherein when the first housing cover is snapped with the second housing cover, the length of the outer retaining wall at least exceeds that of an outer edge of the second housing cover to form a siding.

8. The waterproof housing as claimed in claim 1, wherein adjacent surfaces of the inner retaining wall and the embedding wall are chamfers that are matched with each other.
